(19) United States
(12) Patent Application Publication
(10) Pub. No.: US 2009/0002757 A1
(43) Pub. Date: Jan. 1, 2009

(54) Converter and control method of converter

(75) Inventors: Yoshinao Kitahara, Matsumoto-shi (JP); Kiyoshi Hashimoto, Shiojri-shi (JP); Yasumasa Nakajima, Shiojiri-shi (JP)

Correspondence Address: Edwards Angell Palmer & Dodge LLP, P.O. Box 55874, Boston, MA, 02205, US

(73) Assignee: Seiko Epson Corporation, Tokyo (JP)

(21) Appl. No.: 12/156,156

(22) Filed: May 30, 2008

(30) Foreign Application Priority Data
May 30, 2007 (JP) 2007-143098

(51) Int. Cl. G06F 3/12

(52) U.S. Cl. 358/1.15

(57) ABSTRACT

A converter that converts a data received from a wireless communication interface to a data that is based on a wire-communication standard, the converter including a wire-communication interface that communicates with a printer based on a wire-communication standard, a wireless communication interface that communicates with a terminal unit based on the wireless communication standard, a receiving unit that receives a data from the terminal unit via the wireless-communication interface, a communication establishment unit that establishes a communication with the printer via the wire-communication interface, and a wire-communication unit that transmits the data received by the receiving unit via the established communication to the printer, wherein the communication establishment unit establishes a communication with the printer when the receiving unit receives the data.

### BACKGROUND

1. Technical Field

The present invention relates to a converter, and a control method of a converter.

2. Related Art

Recently, it is general that many of cellular phones have a camera function that can take a picture having the good quality sufficient to be printed. The pictures taken by the cellular phones are printed mainly through the following three methods.

A first method is to print the picture stored in a memory card by reading the picture from the memory card. However, although it is possible that brand new printers can directly print a picture from the memory card, there is a problem that the memory cards mounted in the cellular phones are getting smaller. Accordingly, it is difficult to take out the memory card from the cellular phone. Moreover, it is impossible to mount the memory card taken out from the cellular phone in a printer without the use of a specific adapter. For such reasons, the first method was not easy way for users.

A second method is to print a picture by transmitting an image to a printer by a wireless communication method. However, although there are many cellular phones having an infrared ray communication function, a few of printers has such a function. Accordingly, the second method was also not easy way for users.

A third method is to print a picture by connecting a cellular phone and a printer by PictBridge connection using a USB cable. However, on the contrary to the second method, there are many printers having a PictBridge function but a few of cellular phones has such a function. Moreover, since the USB cable must be additionally prepared and carried, it was very troublesome. Accordingly, this method is not sufficiently convenient for users. In order to solve such problems, JP-A-2007-20037 discloses a converter and a printing method in which a dongle which performs protocol conversion between wireless LAN and PictBridge is connected to a printer, an image is received to the dongle via the wireless LAN, and printing is performed by using a USB cable connected to the PictBridge connector of the printer.

However, since a few of cellular phones has a wireless LAN function the technique disclosed in JP-A-2007-20037 cannot solve the above problem enough. Further, if the dongle which performs protocol conversion between the wireless LAN and the PictBridge is connected to the printer, printing from the PictBridge interface has the priority in the printer. Thus, there is a problem in that printing using other interfaces, for example a memory card inserted in the printer, cannot be performed.

### SUMMARY

An advantage of some aspects of the invention is that it provides a converter and a control method of the converter, which makes a user conveniently perform printing and facilitates direct printing from a terminal unit.

According to one aspect of the invention there is provided a device including a receiving unit, a communication establishment unit, and a wire-communication unit.

It is preferable that the receiving unit receives data from a terminal unit via a wireless interface. The communication establishment unit is triggered when the receiving unit receives the data and establishes a communication with the printer in a communication form based on wire-communication standard via a wire-communication interface. The wire-communication unit transmits the data received by the receiving unit to the printer by the established communication. That is, the communication establishment unit establishes connection between a converter and the printer, and makes the data be in the state in which it can be provided according to demand from the printer.

It is preferable that the converter unit and the printer can be connected via a predetermined terminal, and can communicate with each other based on a predetermined wire-communication standard via a wire-communication interface. The terminal unit is a terminal into which a printer-specific driver cannot be installed or must not be installed due to some problems such as a memory domain or prevention of change of data. That is, the terminal unit is not provided with a printer driver. The terminal unit and the converter can communicate based on a predetermined wireless communication standard via a wireless communication interface.

With such a structure described above, a communication between the printer and the converter is established only when it is needed. Accordingly, even if the converter remains physically connected, printing from other interfaces can be performed by the printer while the data transmission from the terminal unit is not performed. Further, even if the terminal unit into which the driver is not installed, it is possible to perform the printing from the terminal by the use of the converter.

It is preferable that the communication establishment unit includes a data format information acquisition portion which acquires data format information on data formats, which are printable by the printer, from the printer, a determination portion which determines whether the data is printable by the printer on the basis of the acquired data format information, and a communication disconnection portion which disconnects the established communication, and in which the communication disconnection portion disconnects the communication before the wire-communication unit transmits the data to the printer when the determination portion determines as not being printable.

That is, since it is checked whether the data can be printed by the printer in the converter before transmitting the data to the printer, the data which is not printable is not transmitted to the printer.

It is preferable that the data format information acquisition portion further includes a data format information holding portion which holds the acquired data format information even after the established communication is disconnected by the communication disconnection portion, and in which the determination portion allows the transmission of the data to the wire-communication unit to be carried out only when it is determined as being printable by determining whether the data is printable on the basis of the data format information which is held, in the case in which the data format information holding portion holds the data format information. That is, in the case in which the communication is established once and then the communication is disconnected, since the data formation information, data formats that can be printed by the printer, is maintained in the converter, it is possible to determine whether the data received from the terminal unit can be printed by the printer at the time of receiving the data. Accordingly, there is no need to determine whether the printing is possible after receiving and performing the communication with the printer, and thus it is possible to shorten the processing time, which leads to fast response to a user. Moreover, it is possible to enhance processing speed between the terminal unit and the converter by stopping the data reception from the terminal unit in the middle of the data transmission.

It is preferable that the converter further includes a connection preparation unit which disconnects the communication after holding information acquired from the printer upon establishing the communication, after the communication with the printer is established by being triggered when connected with the printer via the wire-communication interface, in which the communication establishment unit reestablishes a communication with the printer using the information held by the connection preparation unit by being triggered when the receiving unit receives the data. That is, if the converter and the printer are connected via the wire-communication interface, the connection is detected by the connection preparation unit, the communication with the printer is established once, and then the communication is disconnected. At this time, since the connection preparation unit disconnects the communication, maintaining the information acquired when establishing the communication, it is possible to establish a communication using the information held by the connection preparation unit when the communication establishment unit reestablishes the communication. Accordingly, it is possible to shorten the time needed to reestablish the communication.

It is preferable that the communication establishment unit can establish a communication based on a second wire-communication standard as well as the predetermined wire-communication standard, and establishes the communication based on either the predetermined wire-communication standard or the second wire-communication standard on the basis of data received by the receiving unit.

That is, if the printer can communicate based on at least two wire-communication standards (for example, PictBridge and USB mass storage class), there can be the case in which printing transmitted based on one wire-communication standard is impossible but printing transmitted based on the other wire-communication standard is possible. Accordingly, in the case in which printing based on one wire-communication standard is impossible, connection and printing based on the other wire-communication standard can be tried. Accordingly, kinds of data formats that can be printed are increased. That is, it is more convenience for a user to print.

It is preferable that the communication establishment unit establishes the communication without waiting for completion of reception of the data in the receiving unit.

That is, the establishment for starting connection with the printer is started at the time when the data transmission from the terminal unit is started and the data format is identified. Accordingly, when the data size of very big, it is possible to makes a printing start timing earlier because the data reception and connection establishment are performed in parallel. Further, it is also possible to perform simultaneous communication. That is, in the case in which the connection between the printer and the converter is established before completion of reception of the data, the storage medium stores the data transmitted from the terminal unit and then the data is transmitted to the printer according to the printer's demand.

The receiving unit creates data prepared by adding layout information based on printing layout information to the data and stores the created data in the storage unit when the printing layout information is present in a predetermined position of the received data.

That is, in the case in which the terminal unit cannot create the data having the layout information, it is possible to convert the image data to the data with the layout information by describing the layout information at a predetermined position of the data.

The invention may be modified in a variety of forms. For example, the above described converted can be implemented as combined with other apparatuses, or can be used together with other methods. The invention may be implemented by a printing system having the converter therein, a control method having processing corresponding to the above-described structure, a control program which causes a computer to execute functions corresponding to the above-described structure, or a recording medium storing the program in a computer-readable manner. Inventions of the printing system, the control method, the control program, and the recording medium into which the program is recorded have the above-described same advantageous effects. All the structures described above are also applicable to the system, method, the program, and the recording medium. The recording medium may include volatile and non-volatile memories, such as semiconductor memories, organic memories, and magnetic memory devices.

### BRIEF DESCRIPTION OF THE DRAWINGS

The invention will be described with reference to the accompanying drawings, wherein like numbers reference like elements.

FIG. 1 is a block diagram roughly illustrating the structure of a USB adapter.

FIG. 2 is a flowchart illustrating the flow of data conversion processing.

FIG. 3 is a flowchart illustrating the flow of PictBridge connection processing.

FIG. 4 is a view illustrating the data flow in data conversion processing.

FIG. 5 is a flowchart illustrating the flow of PictBridge connection processing according to a first modification of the invention.

FIG. 6 is a flowchart illustrating the flow of data conversion processing according to a second modification of the invention.

FIG. 7 is a flowchart illustrating the flow of connection preparation processing.

FIG. 8 is a view illustrating data flow in the second modification.

### DESCRIPTION OF EXEMPLARY EMBODIMENTS

Hereinafter, embodiments of the invention will be described below in the following order:

(1) Structure of a USB adapter;

(2) Data conversion processing;

(3) First modification;

(4) Second modification;

(5) Third modification; and

(6) Other modifications.

### (1) Structure of a USB Adapter

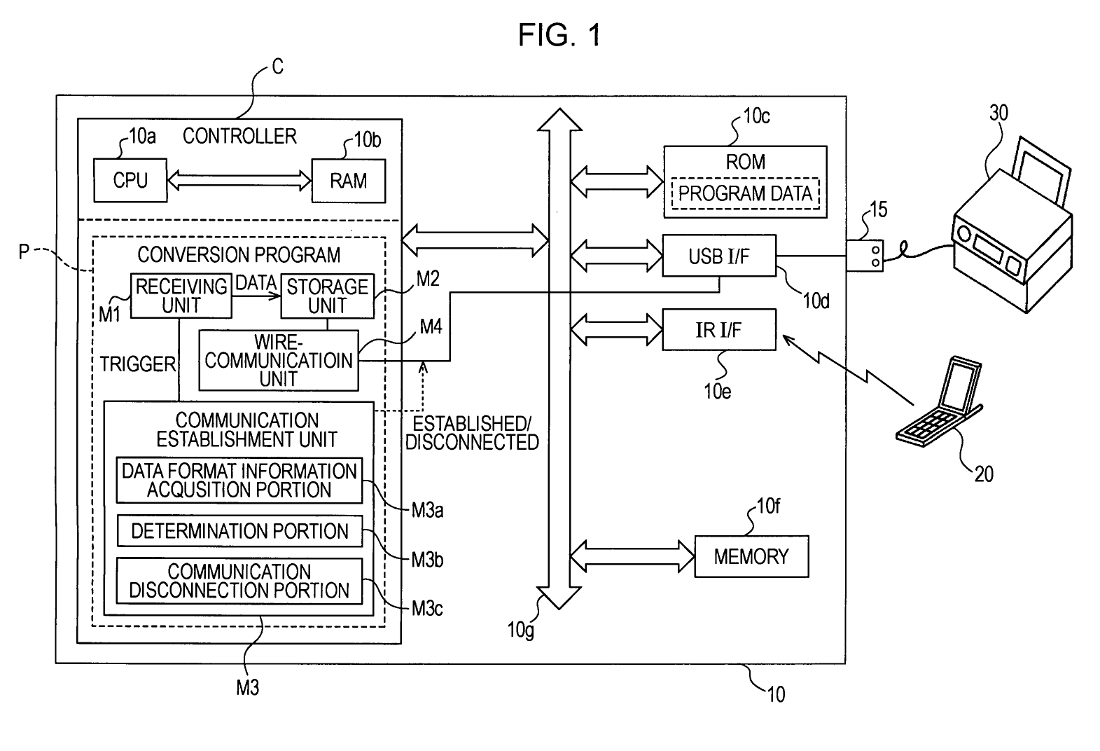

FIG. 1 roughly shows hardware and software configurations of a USB adapter which realizes a converter according to one embodiment of the invention. In FIG. 1, all constituent elements are connected with each other by the USB adapter 10 via a bus 10g. The USB adapter 10 has a controller C consisting of a central processing unit (CPU) 10a and a random access memory (RAM) 10b, a read only memory (ROM) 10c, a USB interface (USB I/F) 10d connected to an external printer (printing device) 30, an infrared I/F (IR I/F) 10e which receives an infrared signal from an external cellular phone 20 (terminal unit), and a memory 10f. In addition, although the data-communication systems in the buss 10g are different according to the constituent elements, it is adjusted so that communication between all the constituent elements may be mutually attained by a chip set which is not shown.

The USB adapter 10 can communicate with the printer 30 based on telecommunications standards, such as PictBridge and USB mass storage class via the USB I/F 10d when the USB terminal 15 is connected to the printer 30. Moreover, the USB adapter 10 supports a hot plug and thus bus power is supplied from the printer 30. In addition, the printer 30 shall have a USB host controller. This USB I/F 10d constitutes a wire-communication interface.

The IR I/F 10e receives and decodes an infrared transmission signal on the basis of an IrDA standard. This IR I/F 10e serves as a wireless-communications interface. In addition, the printer 30 also has a memory card interface which is not shown, and it is possible to print a picture in a memory card inserted in the memory card interface by performing predetermined operation by an operation unit which is not shown. Moreover, the printer 30 also has a function which is called a copy function by which a manuscript scanned by a scanner function which is not shown is printed. That is, although the printer 30 can perform the printing via a plurality of interfaces, priority is given to the printing from the interface which started earlier when printing from the plurality of interfaces competes.

The memory 10f holds the stored data, while power supply voltage is supplied to the USB adapter 10. That is, while the USB adapter 10 is connected to the printer 30 and bus power is supplied, the stored data is maintained, but the remembered information is cleared when the supply of the bus power is stopped. Or when the supply of the bus power is started, a conversion program which will be described below clears the memory. The data stored in the memory 10f can be readable from the printer 30 by performing the communication based on the telecommunication standard of PictBridge or USB mass storage class. This memory 10f serves as a storage medium.

The CPU 10a reads out the program from the ROM 10c and develops it on the RAM 10b, and thus CPU 10a executes the conversion program P by the controller. The conversion program P will be started when the USB adapter 10 is connected to a USB port of the printer 30, and the bus power is supplied. The conversion program P is consisted of a plurality of modules M1 to M4. When the controller C executes these modules M1 to M4, each means of this invention is realized concretely. Hereafter, each module will be explained in detail.

The receiving unit M1 receives image data from the cellular phone 20 via the IR I/F 10e. The cellular phone 20 is operating as an OBject EXchange (OBEX) client, and creates the data which is objectified according to the OBEX protocol. A PUT operation of an IrDA is performed and the infrared transmission of the objectified data is carried out. This receiving unit M1 constitutes a receiving means, and the infrared signal which is used to transmit the data objectified based on the OBEX protocol constitutes a radio signal. Moreover, the IrDA constitutes a wireless-communication standard.

On the other hand, the USB adapter 10 operates as an OBEX server. That is, the receiving unit M1 receives an object which is decrypted by the IR I/F 10e, and acquires the data which the cellular phone 20 transmitted from the object on the basis of the OBEX protocol. The receiving unit M1 will deliver image data to a storage unit M2, when it determines whether the image data is contained in the acquired data and it is determined such that the image data is contained. Furthermore, the receiving unit M1 acquires file-type information of the received image data received, including JPEG, Bitmap, PDF, Xhtml, etc., and outputs this file-type information to a determination portion M3b of the communication establishment unit M3.

The storage unit M2 stores the image data received from the cellular phone 20 in the memory 10f and the storage unit M2 enables reading the file information and access to the file information stored in the memory 10f from the outside. That is, if there are the demand of file information and the transmission demand of a file concerning the file information on the basis of the standard of PictBridge or USB mass storage class from the outside via the USB I/F 10d, the file information or the file is read from the memory 10f, and is transmitted to the outside via the USB I/F 10d. This storage unit M2 constitutes a storage means.

The communication establishment unit M3 controls the USB I/F 10e (wire-communication interface) and communicates with the printer 30 in the communication form based on standards (wire-communications standards), such as PictBridge and USB mass storage class. The communication establishment unit M3 establishes a connection between the USB adapter 10 and the printer 30. This communication establishment unit M3 is provided with DPS Discovery and DPS applications in PictBridge (DPS_GetCapability, DPS_ConfigurePrintService, DPS_StartJob), and a USB I/F control program. This communication establishment unit M3 constitutes a communication establishment means.

The printer 30 which communicates with this communication establishment unit M3 is provided with a USB host controller, a USB mass storage class driver, a disk drive driver, and DPS Discovery and DPS applications (DPS_GetFileInfo, DPS_GetFile) of PictBridge. Moreover, a communication disconnection portion M3c of the communication establishment unit M3 is provided with a switch circuit and thus it is possible to drop the signal wire (D+, D−) of the USB terminal to the ground by the switching of the switch circuit and thus to make the printer fall into the state in which it cannot recognize the USB adapter 10.

That is, In order to enable the printer 30 to be able to detect the connection with the USB adapter 10, the signal wire (D+, D−) must be connected. That is, although each USB terminal of the USB adapter 10 is connected with the printer 30, and the bus power is supplied to the USB adapter 10 from the printer 30, if the signal wire (D+, D−) is not connected, the printer 30 does not detect the connection with the USB adapter 10.

If the connection is established by PictBridge, the communication between the communication establishment unit M3 and the printer 30 will be performed according to DPSJpbFlow. That is, it is checked whether mutual apparatus has a DPS (Digital Photo System or Digital imaging Protocol print Service) function by DPS Discovery, and then the connection is established when the USB adapter 10 acquires service-function information of the printer 30, including a vendor name, a product name, the version of PictBridge, etc., and the capability (paper size, a paper kind, quality of image, a file type, etc.) which can be set up with the DPS application. The information on the capability which the communication establishment unit M3 acquired here and which can be set up is acquired by a data format information acquisition portion M3a. Then, when the wire-communication unit M4 performs a printing start demand, the file information demand and the file demand from the printer 30 are performed. Thus, the image data stored in the memory 10f will be transmitted to the printer 30, and a printing will be performed by the printer 30. This wire-communication unit M4 constitutes a wire-communication means.

On the other hand, when the connection is made by USB mass storage class, the connection will be established by enumeration processing. The enumeration processing means the processing in which the printer 30 discriminates connected devices, allocates addresses to the devices, respectively, and fixes collected descriptor information (a device descriptor, a configuration descriptor, an interface descriptor, and an end point descriptor). If the connection is established, it will be in the state in which the printer 30 can acquire the image data stored in the memory 10f.

The communication establishment unit M3 starts the communication for establishing connection with the printer 30 by being triggered when the receiving unit M1 received the image data from the cellular phone 20 into a trigger. That is, the communication establishment unit M3 performs communication based on PictBridge or USB mass storage class, and establishes connection between the printer 30 and the USB adapter 10. At this time, it is determined that the connection is established by which standard of PictBridge and USB mass storage class according to data conversion processing which will be described below.

### (2) Data Conversion Processing

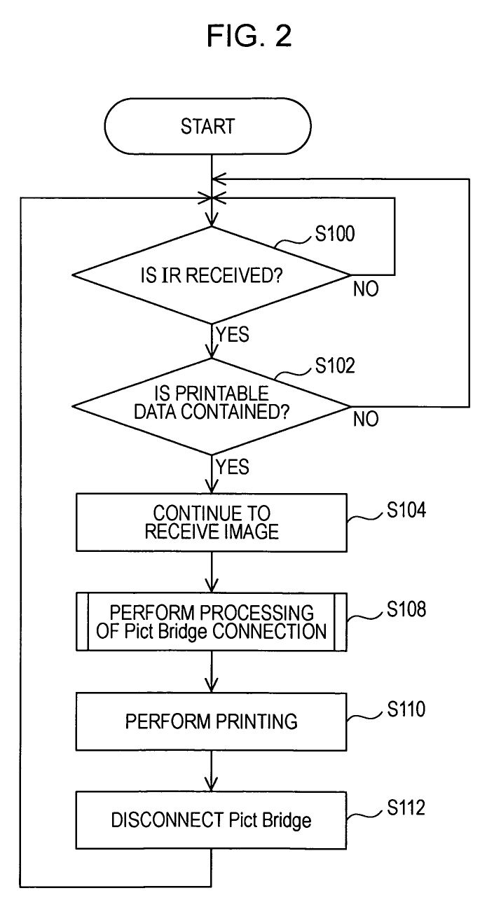

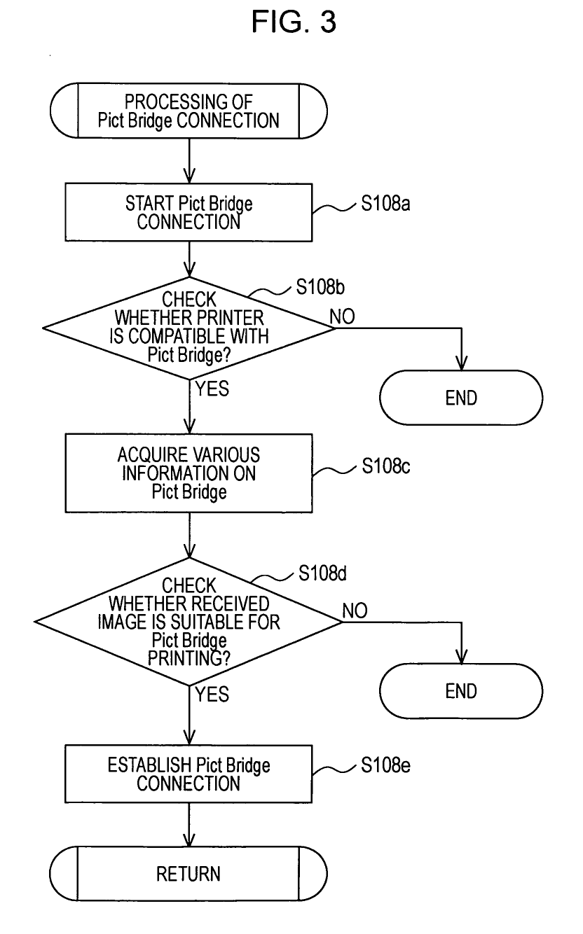

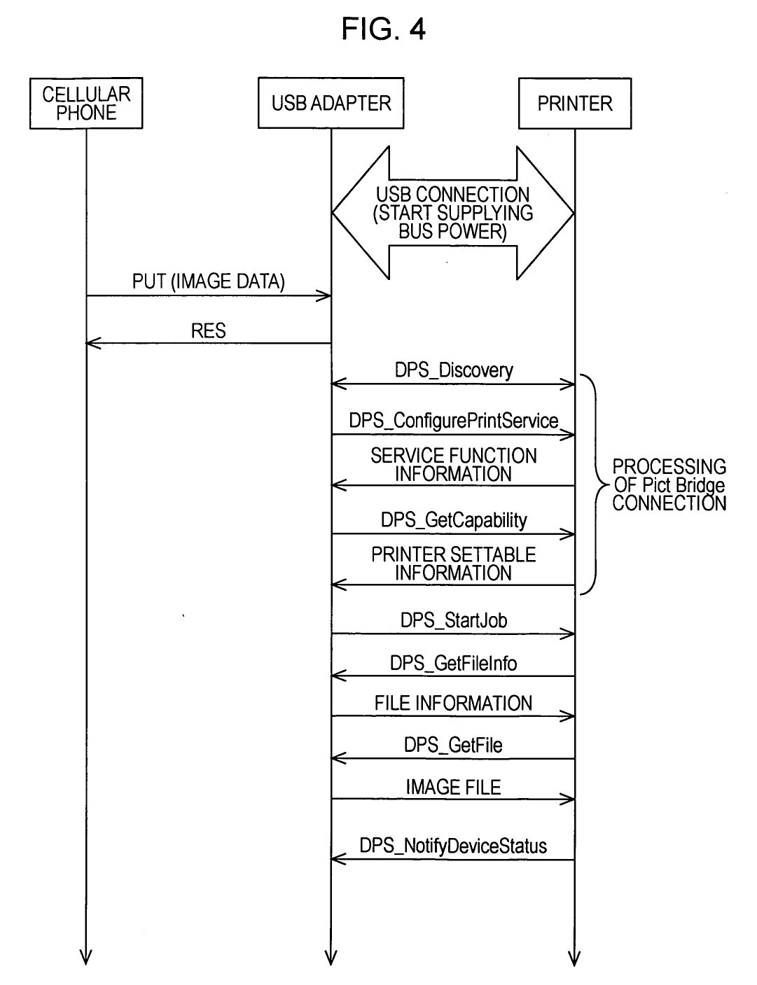

FIG. 2 shows a flowchart illustrating the flow of the data conversion processing executed by the controller C in the USB adapter 10. FIG. 3 shows a flowchart illustrating the flow of PictBridge connection processing executed by the controller C. FIG. 4 shows data flow in the data conversion processing. The processing shown in FIG. 2 is started when the USB adapter 10 is connected to the printer 30 and thus the bus power is supplied from the printer 30 to the USB adapter 10.

If the processing is started by waiting reception of the infrared signal from the cellular phone 20, without making connection with the printer 30 at Step S100. That is, the signal wire (D+, D−) is dropped to the ground, and the printer 30 falls in the state in which connection of the USB adapter 10 is not recognized, and the printer 30 is in stand by state. Step S100 is repeated until the infrared signal is received from the cellular phone 20. If the infrared signal is received from the cellular phone 20, the processing will progress to step S102 as being satisfied of condition.

At step S102, it is determined whether data which can be printed is contained in the infrared signal received at step S100. That is, the receiving unit M1 acquires an object contained in the data received from the IR I/F 10e, and determines whether the object is printable data. Although, in this embodiment, this determination is performed when data to a midway portion is received, and in the state in which the kind of data is identified, that is, in the stage (for example, the stage in which header portion is received, or the stage in which extension information on a file name is received), the determination of step S102 may be performed after receiving all the data to the last.

At Step S102, if the data which can be printed is contained in the received data, the processing will progress to step S104 as being satisfied of condition and data reception will be continued. Although it progresses to step S108 with this embodiment, step S108 may be performed after the entire data (to the last bit thereof) is received at step S104 like the time of step S102. On the other hand, when printable data is not contained in the received data, the processing from step S100 will be repeated as condition failure. Here, the data which can be printed is image data, such as JPEG and Bitmap, and means the data which has a file format which can be printed by PictBridge.

At step S108, the PictBridge connection processing of FIG. 3 will be performed. That is, the PictBridge connection is not started until it is detected that the data which can be printed is received from the cellular phone 20. In the PictBridge connection processing, first, step S108a is performed and thus the communication establishment unit M3 starts connection with the printer 30. That is, the communication establishment unit M3 cancels the ground state of the signal wire (D+, D−), and enables the printer 30 to detect connection of the USB adapter 10. In the meantime, although it is dependent on the size of the data, data reception from the cellular phone 20 determined at step S104 is also performed.

At step S108b, DPS Discovery is performed. That is, the communication establishment unit M3 performs a negotiation with the printer 30, and checks mutually whether both the printer 30 and the USB adapter 10 are apparatuses having a DPS function. If it is determined such that the printer 30 is an apparatus which can support PictBridge, the processing will progress to step S108c as being satisfied condition, but when the printer is not an apparatus which can support PictBridge, the data conversion processing ends as condition failure.

At step S108c, a variety of information required for PictBridge connection is acquired from the printer 30. That is, the communication establishment unit M3 performs DPS_ConfigurePrintService, and acquires the service-function information on the printer 30, including a vendor name, a product name, a version, existence of a print server function, existence of a storage client function, etc. Furthermore, the communication establishment unit M3 performs DPS_GetCapability, and acquires print settable information, including paper size, a paper kind, quality of image, a file type, etc. The information acquired from the printer 30 by these DPS_ConfigurePrintService and DPS_GetCapability processes constitutes data format information and the data format information acquisition portion M3a, which acquires the data format information from the communication establishment unit M3, constitutes a data format information acquisition means.

At step S108d, the determination portion M3b determines whether the image data transmitted from the cellular phone 20 is data which satisfies PictBridge on the basis of the information acquired at step S108c. The PictBridge of the version especially carried in the printer 30 and the USB adapter 10 determines whether the printing of the received image data is supported. If the printing by PictBridge is supported, the processing will progress to step S108e as being satisfied condition. That is, it is regarded that the PictBridge connection is established, and thus it will return to the processing of FIG. 2. On the other hand, when printing by PictBridge is not supported, the cellular phone 20 is notified with the purport that a printing was failed and the data conversion processing ends as condition failure. This notification may be performed by using response status to PUT operation. The determination portion M3b which performs step S108d constitutes a determination means.

If the condition is satisfied at step S108d, a printing job will be performed at step S110. That is, the wire-communication unit M4 issues printing start demand (DPS_StartJob) based on PictBridge to the printer 30 and the printer 30 which answers this printing start demand requests file information (DPS_GetFileInfo). Then, since the wire-communication unit M4 transmits the file information to the printer 30, the printer 30 requests transmission of a file concerning the file information on the basis of the received file information (DPS_GetFile), and the wire-communication unit M4 reads the file from memory 10f, and then transmits it to the printer 30. The printer 30 generates printing data from the received image data and prints out the printing data.

After printing is completed, the communication disconnection portion M3c disconnects the PictBridge connection at step S112. That is, since the printer 30 transmits the “printing is completed” (DPS_NotifyDeviceStatus) to the USB adapter 10 when the printing is completed, the communication disconnection portion M3c which received the status disconnects the PictBridge connection with the printer 30. This disconnection is performed by dropping the potential of the communication line (D+, D−) to the ground. The communication disconnection portion M3c which performs this step S112 constitutes a communication disconnection means.

In the data conversion processing, if the PictBridge-associated information of the printer 30 and various information which are acquired in the PictBridge connection processing of step S108 are stored, when the image data is received next, the determination processing can be performed on the basis of the stored information, without performing the PictBridge connection processing of Step S108. Here, the data format information holding portion M3c, which stores data formation information acquired by the data format information acquisition portion, constitutes a data format information holding means.

Hereinafter, operation of the above-mentioned converter structure according to the embodiment of the invention will be described.

A user inserts the USB terminal of the USB adapter 10 in a USB socket of the printer 30 first. Then, since bus power is supplied to the USB adapter 10 from the printer 30, and thus the SUB adapter 10 comes to fall into the state in which program execution is possible, and a conversion program P is executed. First, the conversion program P controls a switch circuit and connects the signal wire (D+, D−) to the ground. Therefore, although the printer 30 supplies the bus power to the USB adapter 10, the printer 30 cannot detect the connection of the USB adapter 10. Therefore, since the printer 30 does not recognize the USB adapter even if the USB adapter 10 is physically connected to the printer 30, printing from other interfaces provided to the printer 30 will be accomplished. Moreover, if a digital still camera (DSC) is connected to that USB socket when the printer 30 is equipped with other USB sockets, it is also possible to perform printing by the PictBridge connection from the DSC.

Next, the user operates the cellular phone 20, then chooses image data, and finally chooses printing. Then, this image data is objectified on the basis of the OBEX protocol, and is transmitted to the USB adapter 10. The communication based on this OBEX protocol is performed on the infrared transmission. The USB adapter 10 which received the objectified data will try establishment of the PictBridge connection by Hazama with the printer 30 by making this detection as the trigger, if it detects that image data is contained in this object. Also while trying establishment of this connection, reception of image data is continued, and the acquired image data is stored y the memory 10f.

In the middle of establishing connection, it is checked first whether both sides of the printer 30 and the USB adapter 10 are apparatuses supporting PictBridge (DPS Discovery). If it is determined such that they are apparatuses supporting PictBridge, the USB adapter 10 will request and acquire a variety of information from the printer 30 (DPS_ConfigurePrintService, DPS_GetCapability). Next, on the basis of the acquired variety of information, the image data acquired from the cellular phone 20 is checked whether PictBridge printing for the image data is possible. Since the USB adapter 10 will transmit the checking result to the cellular phone 20 if printing by PictBridge is impossible, a user can look at the information displayed on the cellular phone 20, and his or she can find that the printing ends failed.

On the other hand, if PictBridge printing is possible, the printer 30 is instructed to start printing job (DPS_Startjob), and the printer 30 will print by acquiring the file information and the file. After the printer 30 finishes the printing job, the printer 30 transmits the information “printing is completed” to the USB adapter 10 (DPS_NotifyDeviceStatus). Accordingly, the USB adapter 10 transmits the message “printing is completed” to the cellular phone 20. The user can check having carried out the completion of printing, seeing the information displayed on the cellular phone 20.

### (3) First Modification

In the connection preparation processing mentioned above, when PictBridge connection is not possible, the data conversion processing ends. However, there may be data which cannot be printed in PictBridge printing manner but still be printable by the printer 30. For example, image data, a PDF file, etc. which specify the layout of the file by the XHTML file can be printed if the rendering engine is carried in the printer 30.

Therefore, various data can be printable data determined at step S102 of the data conversion processing. For example, a document file created with PDF (Portable Document Format) or word-processing software, a file created with spreadsheet software, files (image data may also be included) created by markup languages, such as HTML or XHTML, or data that can be printed by a rendering engine provided inside the printer 30 are determined as printable data.

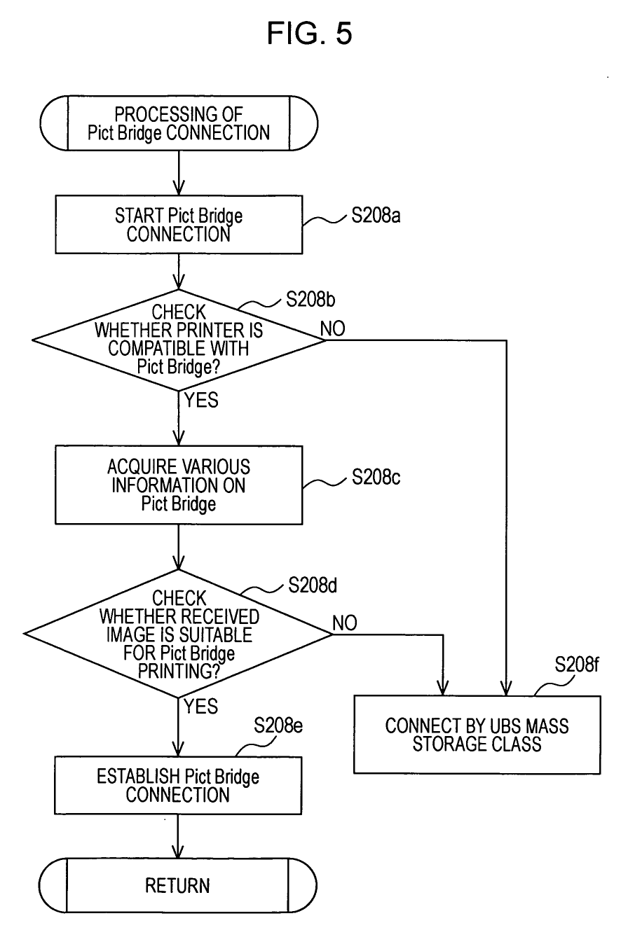

FIG. 5 shows a flow chart according to one modification of the PictBridge connection processing. Since processing of steps S208a, S208c, and S208e are the same as processing of steps S108a, S108b, and S108c shown in the flowchart of FIG. 3, respectively, the explanation about these steps will be omitted in the following explanation.

If PictBridge connection processing is started by step S208a, DPS Discovery will be performed by step S208b. That is, the communication establishment unit M3 negotiates with the printer 30 and checks whether the printer 30 has a DPS function. If it is determined such that the printer 30 is an apparatus supporting PictBridge, the processing will progress to step S208c as being satisfied of condition. On the other hand, if it is determined such that the printer 30 is not an apparatus supporting PictBridge, it progresses to step S208f.

If the variety of information of PictBridge is acquired at step S208c and it progresses to step S208d, it is checked whether the data transmitted from the cellular phone 20 is data that can be printed by PictBridge (the version of PictBridge which are supported by the printer 30 and the USB adapter 10) on the basis of the information acquired by step S208c. If printing by PictBridge is supported, it will progress to step S208e as being satisfied of condition, and return to processing of FIG. 5 because the PictBridge connection is established. On the other hand, in the case in which the data cannot be printed by PictBridge, it will progress to step S208f as condition failure.

At step S208f, the communication for establishing PictBridge connection is ended and communication for establishing USB mass storage class connection is performed. That is, the printer 30 which becomes the host side performs enumeration processing, and starts a USB mass storage class driver. Then, the application performed by the printer 30 can do form the access path which controls a USB host controller via a USB mass storage class driver and a disk driver. Subsequently, the USB mass storage class driver acquires the number of Logical Unit Numbers of the memory 10f of the adapter 10 and the information about the format of Logical unit, and establishes the connection with the USB adapter.

When connection by the USB mass storage class is established at step S208f in this way, a predetermined operation input is performed at the printer 30 side, and the list of the image data stored in the memory 10f is acquired. Desired data is chosen out of the list, and the acquired data undergoes the printing processing. For example, the communication establishment unit M3 transmits the information on the purport that the communication establishment unit M3 is establishing a connection by the USB mass storage class with the instruction to the receiving unit M1, and information on the purport that I want to perform printing operation by the printer 30 to the cellular phone 20 as the response status to the PUT operation.

### (4) Second Modification

In the data conversion processing mentioned above, the PictBridge connection processing is performed after image data was transmitted from the cellular phone 20, and the service-function information on the printer 30 and the printer settable information are acquired. However, it is also possible to perform PictBridge connection processing beforehand. That is, while checking whether the printer 30 is an apparatus supporting PictBridge, the service-function information on the printer 30 and the print settable information are acquired, and the information is held. When constituted in this way, the information used for checking whether the image data can be printed will be stored beforehand in the USB adapter 10. Therefore, it is possible to shorten the time as long as the period between transmission of the image data from the cellular phone 20 and the start timing of printing.

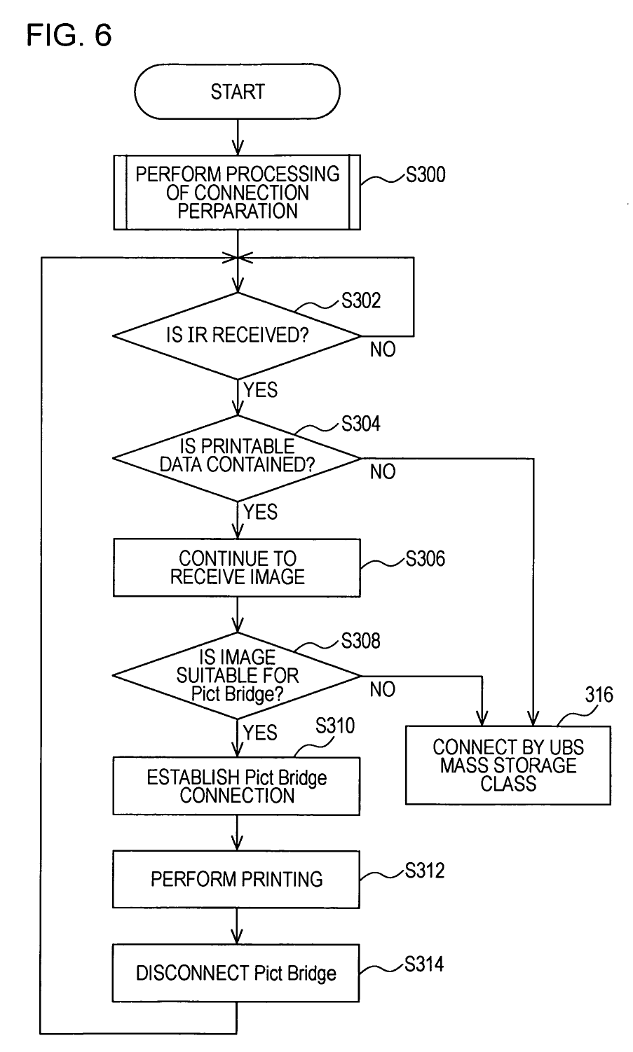

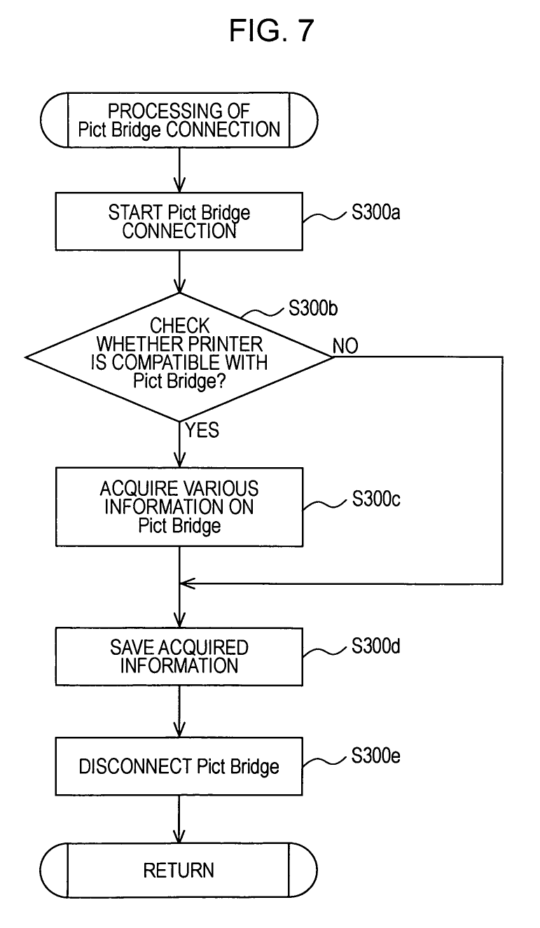

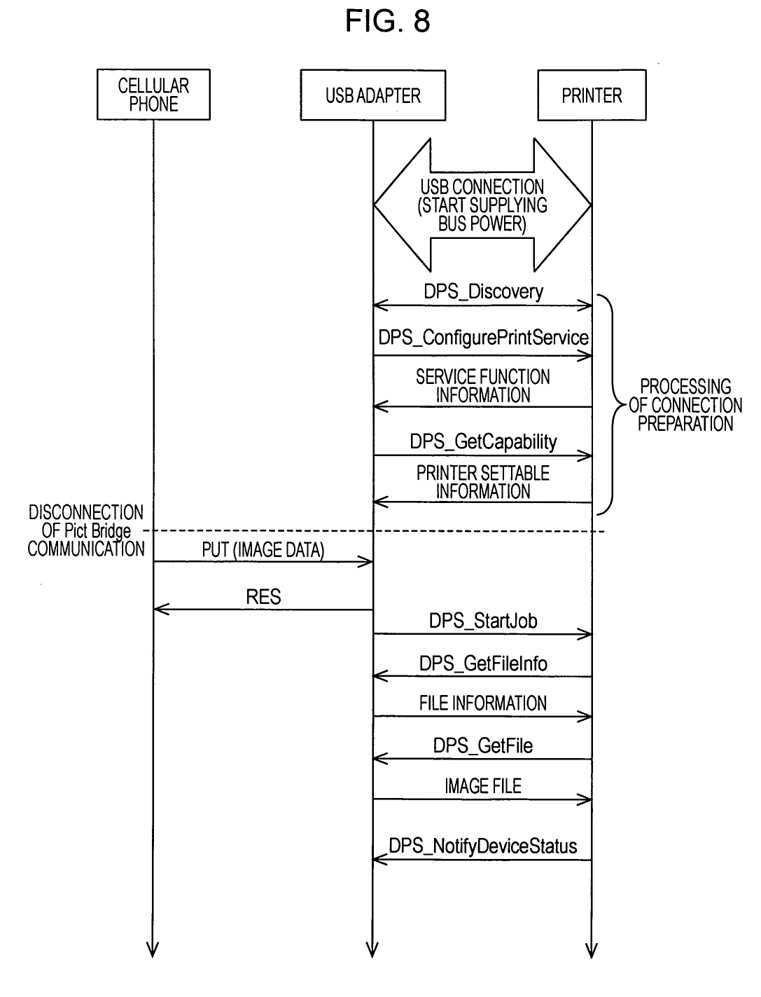

FIG. 6 shows a flowchart illustrating the flow of data conversion processing according to the second modification, FIG. 7 shows a flowchart illustrating the flow of connection preparation processing performed in the data conversion processing according to the second modification, and FIG. 8 is a view illustrating the data flow according to the second modification. In the connection preparation processing of FIG. 7, processing equivalent to the PictBridge connection processing is performed. Since processing of steps S302, S304, S306, S312, and S314 of FIG. 6 are the same as processing of steps S100, S102, S104, S110, and S112 of the embodiment, respectively, explanation thereof will be omitted. Moreover, step S316 is the same as step S208f of FIG. 5, explanation thereof will be also omitted. Further, according to the second embodiment, when the bus power is supplied to the USB adapter 10 as the USB adapter 10 is connected to the printer 30, the connection preparation processing of step S300 will be performed first.

The PictBridge connection is started at step S300a. That is, when the bus power supply to the USB adapter 10 is started, the signal wire (D+, D−) is set up so that the printer 30 can perform a communication.

At step S300b, DPS Discovery is performed. That is, the communication establishment unit M3 negotiates with the printer 30 and checks whether the printer 30 is an apparatus having a DPS function. When it is determined such that the printer 30 is an apparatus supporting the PictBridge, it will progress to step S300c as being satisfied of condition. Conversely, when it is determined such that the printer is not an apparatus supporting the PictBridge, it will progress to step S300d as being condition failure.

At step S300c, a variety of information required for PictBridge connection is acquired from the printer 30. That is, the communication establishment unit M3 performs DPS_ConfigurePrintService, and acquires the service-function information on the printer 30, including a vendor name, a product name, a version, existence of a print server function, existence of a storage client function, etc. Furthermore, the communication establishment unit M3 performs DPS_GetCapability, and acquires the printer settable information, including paper size, a paper kind, quality of image, a file type, etc., which can be printer set up.

At step S300d, the checking information on whether the printer 30 is an apparatus supporting PictBridge, the information being checked in step S300b, and the service-function information or the printer settable information on the printer 30, which is acquired at step S300c, are stored. The memory place for these information may be the RAM 10b, the memory 10f, or a special memory other than these.

At step S300e, the PictBridge connection is cut. That is, the potential of the signal wire (D+, D−) is dropped to the ground, and connection of the USB adapter 10 cannot be recognized by the printer 30. As mentioned above, the communication establishment unit M3 which performs processing of step S300 constitutes a connection preparation means. After the connection preparation processing of step S300 ends, processing of steps S302 to S306 will be performed.

When step S306 ends, determination processing of step S308 is performed. That is, with reference to the information acquired at step S300 and stored in the memory, it is checked whether the image data transmitted from the cellular phone 20 is data supporting PictBridge (PictBridge of the version which is supported by the printer 30 and the USB adapter 10). If the printing by PictBridge is supported, the printing job of step S312 and the PictBridge disconnection processing of step S314 will be performed as being satisfied condition. When printing by PictBridge is not supported, on the other hand, it progresses to step S316 as condition failure, and the connection in the USB mass storage class is performed.

### (5) Third Modification

According to the above described embodiments and modifications, although it is checked whether the received data can be printed by the printer 30 only on the basis of the data received from the cellular phone 20, the data may be positively modified by the USB adapter. In greater detail, the cellular phone 20 adds layout information at a predetermined position of the data which is to be transmitted, and thus the USB adapter 10 can deliver the data to the printing device by adding printing layout information to the received data.

The layout information which the cellular phone 20 transmits can be indicated to a file name. For example, print sheet size is indicated to a file name like “A4.jpg” to specify the size of the printing paper. Moreover, resolution is indicated to a file name like “200dpi.jpg” to specify the print quality at the time of printing. In addition, you may specify printing margin, the printing size of a picture, printing coordinates, etc. Furthermore, you may specify synthesis of a plurality of images, for example, synthesis of photograph frame picture and a photograph picture. In this case, it is possible to specify layout information of the photograph frame picture. In addition, if the file format has a header and a footer, the layout information may be described in the header and the footer. Still further, when transmitting an object from the cellular phone 20, the image data and the layout information are integrated into one file, the file is objectified, and then the objectified file may be transmitted.

In this way, addition of the layout information or synthesis of pictures is directed, the receiving unit M1 selects the file format (for example, XHTML which can be printed by a printer without a printer driver), creates a file in which the layout information is described (for example, Cascading Style Sheets (CSS) etc.), and stores the image data, the layout information, and the created data (for example, XHTML file) in which the image data and the layout information are associated into the storage unit M2. That is, the receiving unit M1 creates the data in which the layout information is added to the image data which is received from the cellular phone 20, and stores the created data into the storage unit M2.

Then, in the printing job which will be performed at step S110, if the file information is requested from the printer 30, the storage unit M2 will transmit an XHTML file to the printer 30. Then, according to description of XHTML, the printer 30 will acquire CSS first, will determine a printing layout, and will print the image data according to the printing layout.

### (6) Other Modifications

In addition to the above described embodiments and modifications, the following modifications are also possible. Although the information on files that can be printed by PictBridge is acquired beforehand in the second and third modifications, it is preferable that a file type list which can be printed not only by PictBridge but by the printer is acquired. With such a method, since it can be checked whether it is printing data which can be printed with the rendering engine of the printer 30 before making connection by USB mass storage class, it is possible to determine whether connection by USB mass storage class should be made.

Although the embodiment mentioned above is explained by employing IrDA as the wireless-communications standard, not only IrDA but wireless-communications standards, such as IrSimple, UFIR, and BlueTooth (registered trademark), are employable. That is, any wiressless-communication standards may be applicable to the invention as long as transmission and reception of the data based on the OBEX protocol are possible.

The standard which performs data transmission in wireless communications is not limited to the OBEX, but it may be any protocols as long as image data transmitted to the USB adapter while being carried on the wireless communication based on the protocols. For example, the communication may be based on the telecommunications standard of wireless LAN.

In addition, this invention is not limited to the embodiments or modifications which were mentioned above. The structure which can be configured by replacing elements or by changing combination of the elements in the embodiments and modifications or the structures which can be configured by replacing elements or by changing combination of the elements in the above described embodiments and modifications and other related arts will be within the scope of the invention.

The entire disclosure of Japanese Patent Application No. 2007-143098, filed May 30, 2007 is expressly incorporated by reference herein.

What is claimed is:

1. A converter that converts a data received from a wireless communication interface to a data that is based on a wire-communication standard, the converter comprising:
a wire-communication interface that communicates with a printer based on a wire-communication standard;
a wireless communication interface that communicates with a terminal unit based on the wireless communication standard;
a receiving unit that receives a data from the terminal unit via the wireless-communication interface;
a communication establishment unit that establishes a communication with the printer via the wire-communication interface; and
a wire-communication unit that transmits the data received by the receiving unit via the established communication to the printer;
wherein the communication establishment unit establishes a communication with the printer by being trigged when the receiving unit receives the data.

2. The converter according to claim 1, the communication establishment unit further comprising:
a data format information acquisition portion that acquires data format information from the printer;
a determination portion that determines the data received by the receiving unit is printable on the basis of the acquired data format information; and
a communication disconnection portion that disconnects the established communication when the determination portion determines the data is not printable.

3. The converter according to claim 2, wherein the data format information acquisition portion further comprising:
a data format information holding portion that holds the acquired data format information even after the established communication is disconnected by the communication disconnection portion;
wherein the determination portion determines the data is printable on the basis of the data format information that is held by the data format information holding portion.

4. The converter according to claim 1, further comprising a connection preparation unit,
wherein the connection preparation unit establishes the communication with the printer when connecting with the printer via the wire-communication interface, holds a information acquired from the printer, and then disconnects the communication,
wherein the communication establishment unit reestablishes a communication with the printer using the information held by the connection preparation unit when the receiving unit receives the data.

5. The converter according to claim 1, wherein the communication establishment unit further comprising a capability of establishing a communication based on a second wire-communication standard,
wherein the communication establishment unit establishes the communication based on either the wire-communication standard or the second wire-communication standard on the basis of data received by the receiving unit.

6. The converter according to claim 1, wherein the communication establishment unit establishes the communication without waiting for completion of reception of the data in the receiving unit.

7. The converter according to claim 1, wherein, when a printing layout information is present in a predetermined position of the received data, the receiving unit adds a layout information based on the printing layout information to the data, and the wire-communication unit transmits the data that is added the layout information via the established communication to the printer.

8. A control method of a converter that converts a data received from a wireless communication interface to a data that is based on a wire-communication standard, the control method comprising:
receiving a data from a terminal unit via the wireless-communication interface;
establishing a communication with the printer via the wire-communication interface based on the wire-communication standard by being triggered when receiving the data; and
transmitting the data received from the terminal unit to the printer by the established communication.
